(19) United States
(12) Patent Application Publication
(10) Pub. No.: US 2026/0352270 A1
(43) Pub. Date: Nov. 5, 2026

(54) SIGNAL PROCESSING APPARATUS AND SIGNAL PROCESSING METHOD

(71) Applicant: NTT, Inc., Tokyo (JP)

(72) Inventors: Kazumitsu SAKAMOTO, Musashino-shi (JP); Yosuke FUJINO, Musashino-shi (JP); Kohei SUZAKI, Musashino-shi (JP); Yohei KATAYAMA, Musashino-shi (JP); Kenji SUZUKI, Musashino-shi (JP); Yasuyoshi KOJIMA, Musashino-shi (JP); Kiyohiko ITOKAWA, Musashino-shi (JP)

(73) Assignee: NTT. Inc., Tokyo (JP)

(21) Appl. No.: 19/119,918

(22) PCT Filed: Nov. 16, 2022
(86) PCT No.: PCT/JP2022/042476

§ 371 Date: Apr. 10, 2025

(51) Int. Cl. H04B 7/0426; H04B 7/08

(52) U.S. Cl. CPC H04B 7/043; H04B 7/08

(57) ABSTRACT

A signal processing device includes: a frame detection unit configured to extract a desired signal's known signal section, which is a known signal section of a desired signal, and an interference signal's known signal section, which is a known signal section of an interference signal, from waveform data indicating a waveform of a wireless signal; a combining unit configured to combine the desired signal with the interference signal to obtain a combined signal so that the desired signal's known signal section and the interference signal's known signal section overlap in time; and a weight generation unit configured to generate weights for reception beam control based on the combined signal.

### TECHNICAL Field

The present invention relates to a signal processing device and a signal processing method.

### BACKGROUND ART

Recently, a satellite IoT (Internet of Things) platform (satellite IoT-PF) has been studied. The satellite IoT-PF collects sensor data from IoT terminals anywhere on the Earth using low Earth orbit satellites. The installation locations for IoT terminals include areas that are difficult to reach with terrestrial communication networks, such as at sea and in mountainous areas.

FIG. 19 is a diagram showing wireless signals received by low-orbiting satellites in a satellite IoT-PF. In FIG. 19, solid arrows represent desired signals from satellite IoT terminals, and dashed arrows represent interference signals from terrestrial IoT terminals. The satellite IoT terminals are targets for collecting data in the satellite IoT-PF. Not only desired signals transmitted from many satellite IoT terminals but also many interference signals from terrestrial IoT terminals that are widely used on the ground arrive at low-orbiting satellites. Therefore, in the satellite IoT-PF, it is necessary to extract and decode weak desired signals transmitted from the desired satellite IoT terminal while those signals interfere with each other. An effective method for this is to mount a plurality of receiving antennas on a low-orbiting satellite and use these receiving antennas to perform reception beam control (see, for example, NPL 1).

In addition, low-orbiting satellites are generally required to be small, lightweight, and power-saving. On the other hand, there are many types of LPWA (Low Power Wide Area) methods used by IOT terminals, such as LoRa (registered trademark), Sigfox (registered trademark), and ELTRES (registered trademark). If a low-orbiting satellite is equipped with receivers that perform decoding in each LPWA method, the receivers become complex, leading to an increase in power consumption. In addition, when a low-orbiting satellite performs reception beam control to extract desired signals from many desired satellite IoT terminals and decoding the extracted signals, a huge amount of signal processing is also required within the low-orbiting satellite, which leads to an increase in power consumption. Therefore, a system configuration in which a ground device performs reception beam control by offline signal processing is being considered (see, for example, NPL 2). In this system configuration, a low-orbiting satellite is equipped with a plurality of receiving antennas. The low-orbiting satellite transmits sampled reception waveform data from each receiving antenna to the ground. A ground device extracts the desired signal from the satellite IoT terminal by performing reception beam control using offline signal processing on the signal obtained from the reception waveform data.

In order to extract the signal of the desired satellite IoT terminal from the signals of many satellite IoT terminals and the signals of terrestrial IoT terminals arriving at the low-orbiting satellite and to decode the extracted signal, it is effective to perform reception beam control as described in NPL 1. As a reception beam control method, adaptive arrays such as MMSE (Minimum Mean Square Error) and CMA (Constant Modulus Algorithm) are widely known. However, in a LPWA method with high reception sensitivity that can be used in a satellite IoT-PF, since the signal reception level is low and is significantly lower than the thermal noise level, even if the reception signal is input to an adaptive array and beam forming processing is performed, an appropriate reception beam cannot be formed and it is difficult to obtain sufficient signal separation performance.

In ELTRES among the LPWA methods, since the signal before spreading processing is a narrowband signal, only the desired signal and the interference signal that interfere with each other at the same frequency after despreading processing are extracted using a narrowband filter, and the extracted signals are used as the input for beamforming processing. In this way, it is possible to suppress the effects of thermal noise and form an appropriate reception beam.

### CITATION LIST

### Non Patent Literature

NPL 1: J. Chu, X. Chen, C. Zhong and Z. Zhang, “Robust Design for NOMA-Based Multibeam LEO Satellite Internet of Things,” IEEE Internet of Things Journal, vol. 8, no. 3, pp. 1959-1970, 2021.

NPL 2: F. Yamashita, D. Goto, Y. Kojima, M. Matsui, K. Itokawa, K. Yoshizawa, K. Sakamoto, Y. Fujino, C. Kato, and M. Nakadai, “920-MHz IoT platform via LEO satellite employing feeder-link MIMO technology,” Proc. 2020 International Conference on Emerging Technologies for Communications (ICETC2020), A1-2, Dec. 2020.

### SUMMARY OF INVENTION

### Technical Problem

However, the LoRa modulated signal modulated by LoRa is a signal obtained by chirp-spectrum-spreading an M-ary FSK signal, and the signal band before spreading processing is not narrow but is widely distributed. Therefore, it is not possible to form an appropriate reception beam by a method similar to that in ELTRES. This is a common problem with signals such as LoRa modulated signals, in which the bandwidth of the signal before spreading processing is not narrow but is widely distributed.

In view of the above circumstances, an object of the present invention is to provide a signal processing device and a signal processing method that realize reception beam control capable of achieving sufficient signal separation performance in an LPWA method even when the reception level of a signal such as a LoRa modulated signal, in which the signal band before spreading processing is not narrow but is widely distributed, is very low.

### Solution to Problem

A signal processing device according to an embodiment of the present invention includes a frame detection unit configured to extract a desired signal's known signal section, which is a known signal section of a desired signal, and an interference signal's known signal section, which is a known signal section of an interference signal, from waveform data indicating a waveform of a wireless signal; a combining unit configured to combine the desired signal with the interference signal to obtain a combined signal so that the desired signal's known signal section and the interference signal's known signal section overlap in time; and a weight generation unit configured to generate weights for reception beam control based on the combined signal.

A signal processing method according to an embodiment of the present invention includes a frame detection step of extracting a desired signal's known signal section, which is a known signal section of a desired signal, and an interference signal's known signal section, which is a known signal section of an interference signal, from waveform data indicating a waveform of a wireless signal; a combining step of combining the desired signal with the interference signal to obtain a combined signal so that the desired signal's known signal section and the interference signal's known signal section overlap in time; and a weight generation step of generating weights for reception beam control based on the combined signal.

### Advantageous Effects of Invention

The present invention makes it possible to achieve sufficient signal separation performance even when the reception level is very low.

### BRIEF DESCRIPTION OF DRAWINGS

FIG. 1 is a diagram showing the functional configuration of a wireless communication system according to an embodiment of the present invention.

FIG. 2 is a block diagram showing the configuration of a wireless communication system according to a first embodiment.

FIG. 3 is a block diagram showing the configuration of a base station according to the first embodiment.

FIG. 4 is a block diagram showing the configuration of a signal processing unit according to the first embodiment.

FIG. 5 is a diagram explaining the difference in extracted signals due to differences in the passband width of a narrowband filter.

FIG. 6 is a diagram showing an example of a desired signal and an interference signal input to a combining unit.

FIG. 7 is a flowchart showing the processing of the wireless communication system according to the first embodiment.

FIG. 8 is a flowchart showing the processing of the wireless communication system according to the first embodiment.

FIG. 9 is a flowchart showing the processing of a signal processing unit and a terminal signal decoding unit according to the first embodiment.

FIG. 10 is a block diagram showing the configuration of a signal processing unit according to a second embodiment.

FIG. 11 is a flowchart showing the processing of a signal processing unit and a terminal signal decoding unit according to the second embodiment.

FIG. 12 is a diagram showing the configuration of a signal processing unit 502 of a modified example of the second embodiment.

FIG. 13 is a block diagram showing the configuration of a mobile relay station according to a third embodiment.

FIG. 14 is a block diagram showing the configuration of a base station according to the third embodiment.

FIG. 15 is a block diagram showing the configuration of a wireless communication system according to a fourth embodiment.

FIG. 16 is a flowchart showing the processing of the wireless communication system according to the fourth embodiment.

FIG. 17 is a flowchart showing the processing of the wireless communication system according to the fourth embodiment.

FIG. 18 is a diagram showing signals processed by a terminal signal reception processing unit 440 when a conventional method and a method according to the present embodiment are applied.

FIG. 19 is a diagram showing a wireless signal received by a low-orbiting satellite in a satellite IoT-PF.

### DESCRIPTION OF EMBODIMENTS

Hereinafter, embodiments of the present invention will be described in detail with reference to the drawings. Note that the same constituent elements in a plurality of drawings will be denoted by the same reference numerals and the description thereof will be omitted.

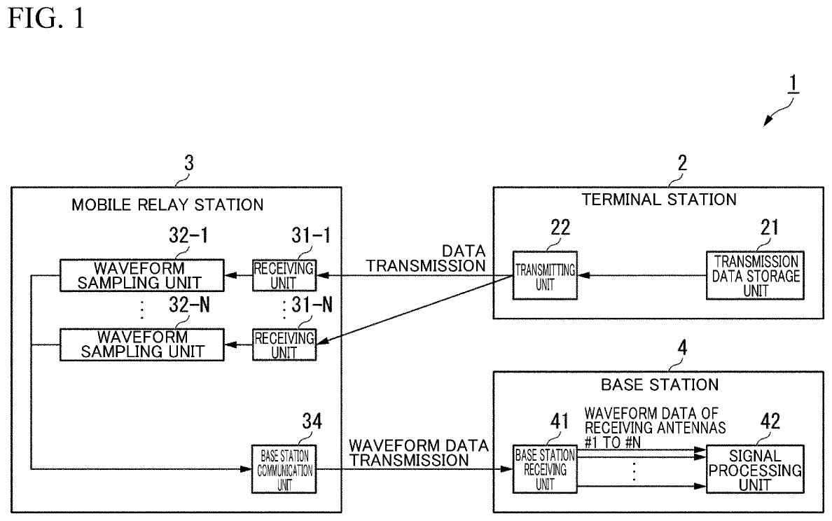

FIG. 1 is a diagram showing the functional configuration of a wireless communication system 1 according to an embodiment of the present invention. The wireless communication system 1 includes a terminal station 2, a mobile relay station 3, and a base station 4. The base station 4 is an example of a signal processing device. In the wireless communication system 1, the number of each of the terminal stations 2, the mobile relay stations 3, and the base stations 4 is arbitrary. It is assumed that there are many terminal stations 2. The mobile relay station 3 moves in the sky above the earth. The terminal station 2 and the base station 4 are installed on the earth. The term “on the earth” includes terrestrial and maritime areas.

Hereinafter, the wireless signal transmitted from the terminal station 2 to the mobile relay station 3 is referred to as a “terminal uplink signal”. Moreover, a wireless signal transmitted from the mobile relay station 3 to the base station 4 is referred to as a “base station downlink signal”.

The terminal station 2 is, for example, a satellite IoT terminal. The terminal station 2 includes a transmission data storage unit 21 and a transmitting unit 22. The transmission data storage unit 21 stores transmission data. The transmission data is, for example, environmental data detected by a sensor. The transmitting unit 22 generates a terminal uplink signal in which the transmission data read from the transmission data storage unit 21 is set. The transmitting unit 22 transmits the terminal uplink signal to the mobile relay station 3 moving in the sky by a wireless method used in a satellite IoT platform.

The mobile relay station 3 is an example of a communication device that moves with the passage of time. The mobile relay station 3 moves in the sky by being mounted on a moving body. The mobile relay station 3 is, for example, provided on an LEO (Low Earth Orbit) satellite. The mobile relay station 3 orbits the Earth along a predetermined orbit. The altitude of the LEO satellite is 2000 km or less, and the LEO satellite orbits over the Earth in about 1.5 hours. The mobile relay station 3 receives terminal uplink signals from each terminal station 2 while moving in the Earth's sky. The mobile relay station 3 accumulates data received through the terminal uplink signal. The mobile relay station 3 transmits the accumulated data to the base station 4 using the base station downlink signal when communication with the base station 4 is possible.

The mobile relay station 3 has an antenna used for wireless communication with the terminal station 2 and an antenna used for wireless communication with the base station 4, and the frequencies used for each wireless communication are generally different. Therefore, the mobile relay station 3 can perform wireless communication related to the terminal station 2 and wireless communication related to the base station 4 in parallel.

It is conceivable to use a relay device mounted on a geostationary satellite or an unmanned aerial vehicle such as a drone or a HAPS (High Altitude Platform Station) as a mobile relay station. However, in the case of a relay station mounted on a geostationary satellite, although the coverage area (footprint) on the ground is wide, the link budget for satellite IOT terminals installed on the ground is very small due to the high altitude. On the other hand, in the case of a relay station mounted on a drone or a HAPS, the link budget is high, but the coverage area is narrow. Furthermore, drones require batteries and HAPSs require solar panels. In the present embodiment, the mobile relay station 3 is mounted on an LEO satellite. Therefore, in addition to keeping the link budget within a limit, the LEO satellite has no air resistance and consumes less fuel because it orbits outside the atmosphere. In addition, the footprint is also large as compared to the case where a relay station is mounted on a drone or a HAPS.

However, since the mobile relay station 3 mounted on the LEO satellite communicates while moving at high speed, the time during which each terminal station 2 and base station 4 can communicate with the mobile relay station 3 is limited. Specifically, from the ground, the mobile relay station 3 passes overhead in about a few minutes. Therefore, the link budget of the mobile relay station 3 mounted on the LEO satellite is smaller than that of a relay station mounted on a drone or HAPS. The mobile relay station 3 receives terminal uplink signals from terminal stations 2 within the coverage of its current location while moving using a plurality of receiving antennas, and stores the waveform data obtained by sampling the waveforms of the terminal uplink signals received by each receiving antenna.

For example, MIMO (Multiple Input Multiple Output) is used for reception using a plurality of receiving antennas. The diversity effect and beamforming effect of communication using a plurality of receiving antennas can improve communication quality. In the following, waveform data obtained by sampling the waveform of a terminal uplink signal received by a certain receiving antenna is also referred to as the waveform data of the receiving antenna or the reception waveform data.

As shown in FIG. 1, the mobile relay station 3 has receiving units 31-1 to 31-N, waveform sampling units 32-1 to 32-N, and a base station communication unit 34. The mobile relay station 3 has N (N is an integer of 2 or more) receiving antennas (not shown) that receive the terminal uplink signal. The N receiving antennas are referred to as receiving antennas #1 to #N. The receiving unit 31-n (n is an integer of 1 or more and N or less) receives the terminal uplink signal using the receiving antenna #n. The waveform sampling unit 32-n samples the reception waveform of the terminal uplink signal received by the receiving unit 31-n, and stores the waveform data obtained by sampling. The base station communication unit 34 transmits the base station downlink signal, in which the waveform data of the receiving antennas #1 to #N is set, to the base station 4 at the timing when the base station 4 is in its coverage.

The base station 4 has a base station receiving unit 41 and a signal processing unit 42. The base station receiving unit 41 obtains waveform data from the base station downlink signal received from the mobile relay station 3. The signal processing unit 42 obtains data transmitted by the terminal station 2 by performing reception signal processing and decoding on the terminal uplink signal represented by the waveform data. In the reception signal processing, the signal processing unit 42 compensates for the Doppler shift and the Doppler shift fluctuation, which is the fluctuation at that time, for each piece of reception waveform data, and then performs reception beam control using an adaptive array. The Doppler shift fluctuation is obtained by differentiating the Doppler shift. The signal processing unit 42 decodes the reception signal that has been subjected to reception beam control. Each embodiment will be described below.

### First Embodiment

In the first embodiment, the Doppler shift fluctuation is estimated using a known signal.

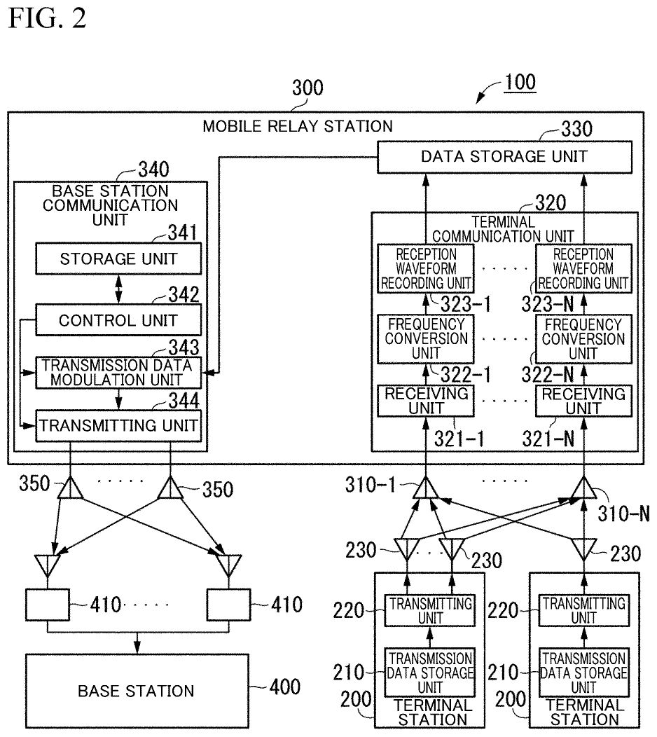

FIG. 2 is a block diagram showing the configuration of a wireless communication system 100 according to the first embodiment. The wireless communication system 100 includes a terminal station 200, a mobile relay station 300, and a base station 400. The wireless communication system 100, the terminal station 200, the mobile relay station 300, and the base station 400 correspond to the wireless communication system 1, the terminal station 2, the mobile relay station 3, and the base station 4 in FIG. 1, respectively.

The terminal station 200 includes a transmission data storage unit 210, a transmitting unit 220, and one or more antennas 230. The transmission data storage unit 210 and the transmitting unit 220 correspond to the transmission data storage unit 21 and the transmitting unit 22 of the terminal station 2 shown in FIG. 1, respectively.

The transmission data storage unit 210 stores sensor data and the like. The transmitting unit 220 reads the sensor data from the transmission data storage unit 210 as terminal transmission data. The transmitting unit 220 wirelessly transmits a terminal uplink signal, in which the read-out terminal transmission data is set, from the antenna 230. The transmitting unit 220 transmits a signal, for example, using LoRaWAN (registered trademark). The transmitting unit 220 may use any wireless communication method among LPWA (Low Power Wide Area) methods as long as the signal band before spreading processing is not narrow but is widely distributed, such as LoRaWAN. Further, the transmitting unit 220 may transmit signals to another terminal station 200 through time division multiplexing, OFDM (Orthogonal Frequency Division Multiplexing), or the like. The transmitting unit 220 determines a channel and a transmission timing to be used by the host station to transmit the terminal uplink signal by a method determined in advance in a wireless communication method to be used. The transmitting unit 220 may transmit a signal in which an ID indicating that it is a desired signal is stored in the payload.

The mobile relay station 300 includes N antennas 310 (N is an integer of 2 or more), a terminal communication unit 320, a data storage unit 330, a base station communication unit 340, and M antennas 350 (M is an integer of 1 or more). In the present embodiment, an example in which M is 2 or more will be described.

The antenna 310 is a receiving antenna that receives terminal uplink signals transmitted from the terminal station 200. The N antennas 310 are referred to as antennas 310-1 to 310-N. A receiving antenna #n is an antenna 310-n that has received a terminal uplink signal.

The terminal communication unit 320 includes N receiving units 321, N frequency conversion units 322, and N reception waveform recording units 323. The N receiving units 321 are referred to as receiving units 321-1 to 321-N, the N frequency conversion units 322 are referred to as frequency conversion units 322-1 to 322-N, and the N reception waveform recording units 323 are referred to as reception waveform recording units 323-1 to 323-N.

A receiving unit 321-n (n is an integer of 1 or more and N or less) receives a terminal uplink signal through an antenna 310-n. The frequency conversion unit 322-n frequency-converts the terminal uplink signal received by the receiving unit 321-n from an RF (Radio Frequency) signal to a baseband signal. A quadrature demodulator or the like is used for the frequency conversion. The receiving unit 321-n and the frequency conversion unit 322-n correspond to the receiving unit 31-n in FIG. 1.

The reception waveform recording unit 323-n samples the waveform of the terminal uplink signal of which the frequency has been converted by the frequency conversion unit 322-n, and generates waveform data indicating the value obtained by sampling. The reception waveform recording unit 323-n writes reception waveform information, in which the antenna identification information of the antenna 310-n, the reception time of the terminal uplink signal at the antenna 310-n, and the generated waveform data are set, into the data storage unit 330. The antenna identification information is information that identifies each antenna 310. The reception waveform recording unit 323-n corresponds to the waveform sampling unit 32-n in FIG. 1. The data storage unit 330 stores the reception waveform information generated by the reception waveform recording unit 323.

The base station communication unit 340 transmits a base station downlink signal to the base station 400. The base station communication unit 340 corresponds to the base station communication unit 34 in FIG. 1. The base station communication unit 340 includes a storage unit 341, a control unit 342, a transmission data modulation unit 343, and a transmitting unit 344. The storage unit 341 stores a transmission start timing calculated in advance based on the orbit information of the LEO Satellite carrying the host station and the position of the base station 400. Furthermore, in the case where there are a plurality of antennas 350, the storage unit 341 may store in advance weights for each transmission time of the base station downlink signals transmitted from each antenna 350. The weight for each transmission time is calculated based on the orbit information of the LEO satellite and the position of each antenna station 410 equipped in the base station 400. A constant weight may be used regardless of the transmission time.

The control unit 342 controls the transmission data modulation unit 343 and the transmitting unit 344 to transmit the base station downlink signal to the base station 400 at the transmission start timing stored in the storage unit 341. Furthermore, the control unit 342 instructs the transmitting unit 344 of the weight for each transmission time read from the storage unit 341. The transmission data modulation unit 343 reads the reception waveform information stored in the data storage unit 330 as the transmission data. The transmission data modulation unit 343 converts the transmission data into parallel signals and then modulates them. The transmitting unit 344 weights the modulated parallel signals with the weights instructed by the control unit 342, and generates base station downlink signals to be transmitted from each antenna 350. The transmitting unit 344 transmits the generated base station downlink signals from the antenna 350, for example, by MIMO. The antenna 350 is a transmitting antenna that transmits the base station downlink signals wirelessly. The antenna 350 may also receive a base station uplink signal transmitted wirelessly from the base station 400.

Note that when there is only one antenna 350, the control unit 342 does not instruct the transmitting unit 344 about the weight. The transmission data modulation unit 343 modulates the transmission data into a transmission signal to be transmitted from one antenna 350. The transmitting unit 344 transmits the modulated transmission signal from the antenna 350.

The base station 400 includes one or more antenna stations 410.

The following describes an example in which there are a plurality of antenna stations 410. The plurality of antenna stations 410 are arranged at positions separated from each other so that the difference in the arrival angles of the signals from the plurality of antennas 350 of the mobile relay station 300 is large.

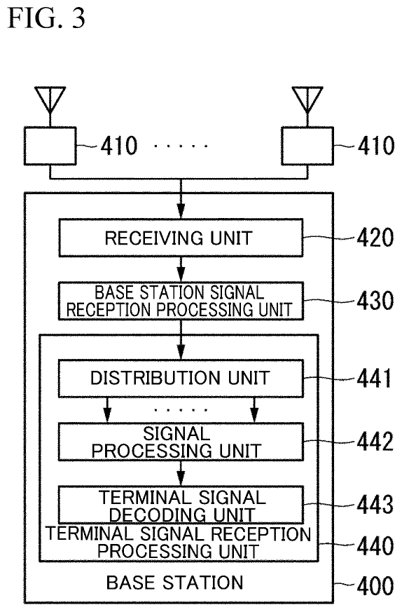

FIG. 3 is a diagram illustrating a configuration example of the base station 400. The base station 400 includes a plurality of antenna stations 410, a receiving unit 420, a base station signal reception processing unit 430, and a terminal signal reception processing unit 440. The receiving unit 420 and the base station signal reception processing unit 430 correspond to the base station receiving unit 41 in FIG. 1, and the terminal signal reception processing unit 440 corresponds to the signal processing unit 42 in FIG. 1.

The antenna station 410 converts the base station downlink signal received from the mobile relay station 300 into an electrical signal and outputs it to the receiving unit 420. The receiving unit 420 aggregates base station downlink signals received from a plurality of antenna stations 410. The receiving unit 420 stores weights for each reception time of the base station downlink signals received by each antenna station 410 based on orbit information of the LEO satellites and the position of each antenna station 410. The receiving unit 420 multiplies the base station downlink signal input from each antenna station 410 by the weight corresponding to the reception time of the base station downlink signal, and combines the reception signals multiplied by the weights. The same weight may be used regardless of the reception time.

The base station signal reception processing unit 430 receives, as input, the reception signal combined by the receiving unit 420. If there is only one antenna station 410, or if the base station 400 does not have the antenna station 410 but has only one antenna, the base station 400 does not have the receiving unit 420, and the base station signal reception processing unit 430 receives the base station downlink signal received from the antenna station 410 or the antenna as the reception signal. The base station signal reception processing unit 430 decodes the input reception signal and obtains reception waveform information. The base station signal reception processing unit 430 outputs the reception waveform information to the terminal signal reception processing unit 440.

The terminal signal reception processing unit 440 performs processing of receiving the terminal uplink signal indicated by the reception waveform information. The terminal signal reception processing unit 440 performs reception processing using the wireless communication method used by the terminal station 200 for transmission to obtain terminal transmission data. The terminal signal reception processing unit 440 includes a distribution unit 441, a signal processing unit 442, and a terminal signal decoding unit 443.

The distribution unit 441 reads the waveform data of the receiving antennas #1 to #N at the same reception time from the reception waveform information and outputs the read waveform data to the signal processing unit 442. The waveform data of the receiving antenna #n is waveform data associated with the antenna identification information of the antenna 310-n. The signal processing unit 442 performs processing such as frame detection (terminal signal detection), Doppler shift fluctuation compensation, filtering, and reception beam control on the waveform data of the receiving antennas #1 to #N. In the present embodiment, the description of the receiving processing performed by other general wireless communication devices is omitted.

Frame detection is processing of detecting a section including a terminal transmission frame of a terminal uplink signal from the waveform data. The signal processing unit 442 performs frame detection on the waveform data of each of the receiving antennas #1 to #N, and detects a known signal section of a desired signal and a known signal section of an interference signal included in the waveform data. The signal processing unit 442 performs Doppler shift fluctuation compensation on each detected terminal transmission frame. The signal processing unit 442 despreads the desired signal and the interference signal, and converts them into a narrowband signal using a narrowband filter. The signal processing unit 442 combines the narrowband signal of the desired signal with the narrowband signal of the interference signal, and generates weights for reception beam control based on the combined signal. The signal processing unit 442 multiplies the desired signal and the interference signal, which have been subjected to Doppler shift fluctuation compensation, by weights and adds and combines them. The signal processing unit 442 outputs a reception signal obtained from the combined waveform data to the terminal signal decoding unit 443.

The terminal signal decoding unit 443 performs reception processing performed by a general wireless communication device on the signal output by the signal processing unit 442 and decodes the signal to obtain the terminal transmission data transmitted from the terminal station 200. The terminal signal decoding unit 443 can also use a decoding method with a high calculation load, such as SIC (Successive Interference Cancellation).

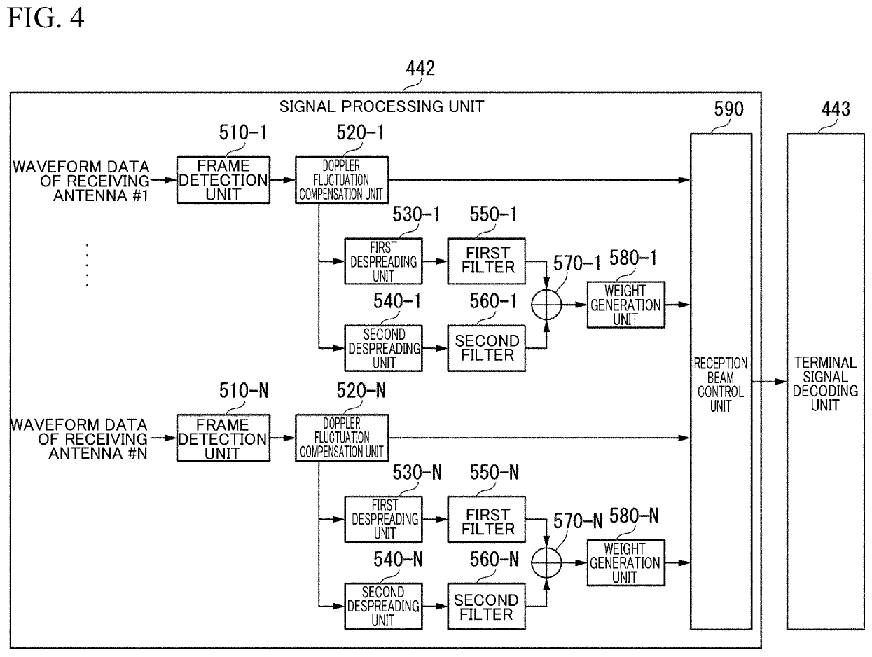

FIG. 4 is a diagram showing a detailed configuration of the signal processing unit 442. The signal processing unit 442 includes frame detection units 510-1 to 510-N, Doppler fluctuation compensation units 520-1 to 520-N, first despreading units 530-1 to 530-N, second despreading units 540-1 to 540-N, first filters 550-1 to 550-N, second filters 560-1 to 560-N, combining units 570-1 to 570-N, weight generation units 580-1, and a reception beam control unit 590.

The frame detection unit 510-n (n is an integer of 1 or more and N or less) performs frame detection on the waveform data of the receiving antenna #n. The frame detection unit 510-n calculates the cross-correlation between the transmission known signal and the reception signal waveform indicated by the waveform data. As a result, the frame detection unit 510-n detects a predetermined position of the reception frame in the waveform data of the receiving antenna #n. The transmission known signal is a known signal such as a preamble that is set at a predetermined position such as the beginning of a frame defined by the frame format of each LPWA method used by the satellite IoT terminal accommodated in the satellite IoT-PF.

Specifically, a plurality of transmission known signals with different types of frequency shifts f [Hz] added are prepared in advance. The Doppler shift range expected from the frequency of the terminal uplink signal and the orbit information of the mobile relay station 300 is assumed to be −dfₘₐₓ to dfₘₐₓ. For example, when transmitting a 920 MHz terminal uplink signal to a mobile relay station 300 at an orbit altitude of 570 km, the expected Doppler shift range is approximately −20 [kHz] to 20 [kHz]. The search interval fₛₜₑₚ is set to several Hz, and transmission known signals with frequency shifts f of −dfₘₐₓ, −dfₘₐₓ+fₛₜₑₚ, −dfₘₐₓ+2×fₛₜₑₚ, . . . dfₘₐₓ−2×fₛₜₑₚ, dfₘₐₓ−fₛₜₑₚ, and dfₘₐₓ added are prepared. These transmission known signals are stored in advance in a storage unit inside or outside the frame detection unit 510-n. The frame detection unit 510-n calculates the cross-correlation between each transmission known signal and the reception signal waveform indicated by the waveform data. The frame detection unit 510-n searches for a transmission known signal for which the correlation value of the cross-correlation reaches the maximum or is equal to or greater than a threshold, and detects the position of the reception signal waveform where the correlation value is obtained as the position of the known signal. In this way, the frame detection unit 510-n can detect a known signal section in which a known signal such as a preamble is set in the reception frame, for example. The detected known signal section of the desired signal is referred to as a desired signal's known signal section, and the detected known signal section of the interference signal is referred to as an interference signal's known signal section. Note that both the desired signal and the interference signal are LoRa modulated signals, and the signal frames of the LoRa modulated signals have the same known signal section. Thus, at the time when the frame detection unit 510-n detects a known signal section, it is unclear whether the known signal section is a desired signal's known signal section or an interference signal's known signal section. For example, by reading the ID of the payload section after decoding by the terminal signal decoding unit 443 described later, it is possible to distinguish whether the signal is a desired signal or an interference signal.

When the frame detection unit 510-n detects the position of a known signal in a reception frame in the waveform data, the frame detection unit 510-n extracts a section of a frame length defined by a frame format from the waveform data, or identifies the end position of the frame based on the frame length information described in the header of the reception frame to extract the frame section.

The frequency shift added to the searched transmission known signal is almost the same as the Doppler shift received by the terminal uplink signal of the desired signal. Therefore, the frame detection unit 510-n may use the frequency shift added to the searched transmission known signal as an estimated value of the Doppler shift and perform Doppler shift compensation on the waveform data.

In the above, a case where a transmission known signal to which different types of frequency shifts are added is described, but in addition to the addition of frequency shift, a transmission known signal to which different types of frequency fluctuations are also added may be used, as in the method B of Doppler shift fluctuation compensation described later. That is, the frame detection unit 510-n may prepare in advance a plurality of transmission known signals to which combinations of different types of frequency shifts and different types of frequency fluctuations are added, and calculate the cross-correlation between each of these transmission known signals and the reception signal waveform indicated by the waveform data of the receiving antenna #n. The frequency fluctuation added to the transmission known signal corresponds to the Doppler shift fluctuation received by the terminal uplink signal. For example, in the same manner as above, when a 920 MHz terminal uplink signal is transmitted to a mobile relay station 300 at an orbit altitude of 570 km, the expected range of Doppler shift fluctuation is approximately −300 Hz/s to −50 Hz/s. Alternatively, the frame detection unit 510-n may use a commonly used method, such as detecting a section in the waveform data of the receiving antenna #n where the time domain waveform has a certain amplitude or more as a section including a terminal transmission frame.

The Doppler fluctuation compensation unit 520-n performs Doppler shift fluctuation compensation on the reception frame extracted by the frame detection unit 510-n. The Doppler shift fluctuation compensation is processing of compensating for the Doppler shift fluctuation received by the desired signal. In the present embodiment, the Doppler fluctuation compensation unit 520-n estimates the Doppler shift fluctuation by using a known signal in the reception frame using one of the following methods A and B, and performs compensation to cancel the estimated Doppler shift fluctuation on the waveform data of the reception frame section. The Doppler fluctuation compensation unit 520-n outputs the reception frame for which the Doppler shift fluctuations have been compensated to the first despreading unit 530-n, the second despreading unit 540-n, and the reception beam control unit 590.

(Method A) The Doppler fluctuation compensation unit 520-n calculates (estimates) the Doppler shift fluctuation based on the amount of phase rotation in a known signal section such as the beginning of the reception frame. The known signal section is a section in which a known signal such as a preamble is set in the reception frame. The Doppler fluctuation compensation unit 520-n compensates for the Doppler shift fluctuation by adding a phase rotation that cancels the calculated Doppler shift fluctuation throughout the entire reception frame section. Note that some LPWA methods, such as ELTRES (registered trademark), have known signals distributed throughout the entire packet. In that case, the Doppler shift fluctuation can be estimated and compensated for based on the amount of phase rotation received by the distributed known signals. In this way, the present embodiment is not limited to a configuration that uses a preamble at the beginning of the frame.

(Method B) A plurality of fluctuation detection signals are prepared in advance, in which frequency fluctuations corresponding to different Doppler shift fluctuations are added to a known signal such as a preamble set at a predetermined position such as the beginning of a frame defined by the frame format of the LPWA method. For example, assume that the Doppler shift fluctuations expected based on the terminal uplink signal frequency, which is the frequency of the terminal uplink signal, and the orbit altitude of the satellite carrying the mobile relay station 300 at each time are −300 Hz/s to −50 Hz/s. In this case, a plurality of types of fluctuation detection signals are prepared, in which frequency fluctuations in increments of several Hertz between −300 Hz/s to −50 Hz/s are added to the known signal. These plurality of types of fluctuation detection signals are stored in a storage unit inside or outside the Doppler fluctuation compensation unit 520-n. The Doppler fluctuation compensation unit 520-n calculates the cross-correlation between the reception frame extracted from the waveform data of the antenna #n and each fluctuation detection signal. When the correlation value of the cross-correlation reaches the maximum or is equal to or greater than a threshold, the Doppler fluctuation compensation unit 520-n uses the frequency fluctuation added to the fluctuation detection signal used to calculate the correlation value as an estimated value of the Doppler shift fluctuation. The Doppler fluctuation compensation unit 520-n compensates for the Doppler shift fluctuation by adding a phase rotation that cancels the estimated Doppler shift fluctuation over the entire reception frame section obtained from the waveform data of the antenna #n.

The first despreading unit 530-n performs despreading (down-chirp processing) on the desired signal in the desired signal's known signal section where the Doppler shift fluctuation compensation has been performed by the Doppler fluctuation compensation unit 520-n, and performs processing to narrow the signal bandwidth.

The second despreading unit 540-n performs despreading (down-chirp processing) on the interference signal in the interference signal's known signal section where the Doppler shift fluctuation compensation has been performed by the Doppler fluctuation compensation unit 520-n, and performs processing to narrow the signal bandwidth. As described above, since the desired signal and the interference signal cannot be distinguished at the timing of despreading, the first despreading unit 530-n and the second despreading unit 540-n may perform despreading on either the desired signal or the interference signal.

The first filter 550-n filters the desired signal in the desired signal's known signal section despread by the first despreading unit 530-n. The filtering is processing of band-limiting the desired signal that has been subjected to Doppler shift fluctuation compensation and despread using a narrowband filter. By using the narrowband filter to extract only the band around the desired signal, the influence of many interference signals outside the desired signal band is suppressed. The passband width of the narrowband filter is set to the same as the transmission signal bandwidth of the desired signal defined by the LPWA method to be extracted, or to a bandwidth slightly wider (with a small margin) than the transmission bandwidth. The first filter 550-noutputs the filtered desired signal to the combining unit 570-n.

The passband width of the narrowband filter of the first filter 550-nmay be set according to the reception level of the desired signal. The reception level of the desired signal is the signal level of the desired signal recorded by the reception waveform recording unit 323. The first filter 550-n may set the passband width of the narrowband filter from the desired signal level based on the correspondence relationship between the reception level of the desired signal and the passband width of the narrowband filter. The passband width of the narrowband filter is set so as to include the band of the skirt part of the despread spectrum of the desired signal after despreading.

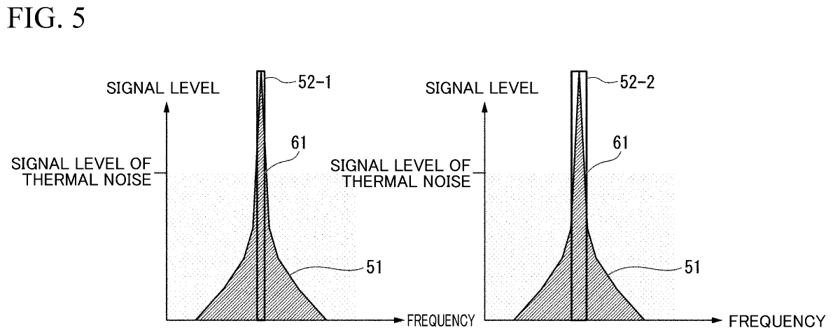

FIG. 5 is a diagram explaining the difference in the extracted signal due to the difference in the passband width of the narrowband filter. FIG. 5 shows filtering of the despread spectrum 51 of the desired signal after despreading by the filters 52-1 and 52-2. The passband width of the filter 52-1 is narrower than that of the filter 52-2. When filtering by the filter 52-1, the component 61 near the thermal noise level of the distribution of the despread spectrum 51 is cut and is not included in the extracted signal. This causes distortion in the desired signal, leading to deterioration in the characteristics of the weight generation processing by the weight generation unit 580. When filtering by the filter 52-2, the component 61 near the thermal noise level of the distribution of the despread spectrum 51 is not cut and is included in the extracted signal. This prevents distortion of the desired signal and allows the weight generation unit 580 to perform appropriate weight generation processing.

The second filter 560-n, like the first filter 550-n, filters the interference signal in the known signal section of the interference signal. By using a narrowband filter to extract only the band around the interference signal, it is possible to cut out thermal noise outside the band and suppress its influence. As described above, since the desired signal and the interference signal cannot be distinguished at the timing of filtering, the first filter 550-n and the second filter 560-n may filter either the desired signal or the interference signal. For the desired signal and the interference signal, the peak value of the signal level of the narrowband spectrum after despreading is proportional to the reception level. For example, the first filter 550-n sets the filter bandwidth based on the peak value of the signal level of the narrowband spectrum after despreading by the first despreading unit 530-n and performs filtering.

Furthermore, for example, the second filter 560-n sets the filter bandwidth based on the peak value of the signal level of the narrowband spectrum after despreading by the second despreading unit 540-n and performs filtering. Since the peak value of the signal level of the narrowband spectrum after despreading is proportional to the reception level, the first filter 550-n and the second filter 560-n set the filter bandwidth using a correspondence relationship between the peak value of the signal level of the narrowband spectrum after despreading and the filter bandwidth or a calculation formula for calculating the filter bandwidth from the peak value of the signal level of the narrowband spectrum after despreading. The correspondence relationship and the calculation formula are determined in advance when the signal processing unit 442 is designed.

The combining unit 570-n combines the narrowband signal of the desired signal filtered by the first filter 550-n and the narrowband signal of the interference signal filtered by the second filter 560-n. The combining unit 570-n combines the two narrowband signals so that the known signal section of the desired signal and the known signal section of the interference signal overlap in time.

If the start time of the desired signal's known signal section is T₁ and the start time of the interference signal's known signal section is T₂, for example, the combining unit 570-n applies a time delay of T₂-T₁ to the desired signal's known signal section so that the desired signal's known signal section and the interference signal's known signal section overlap in time. The combining unit 570-n may apply a time delay of T₂-T₁ to the desired signal's known signal section so that the desired signal's known signal section and the interference signal's known signal section overlap completely in time, or may apply a time delay that is different from T₂-T₁ to the desired signal's known signal section so that the desired signal's known signal section and the interference signal's known signal section overlap partially in time.

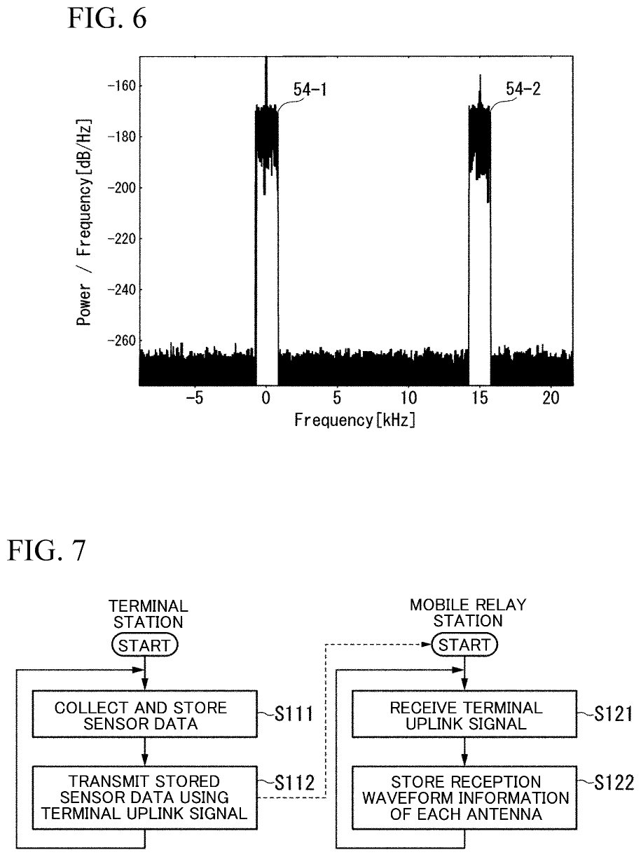

When the difference between the frequency of the desired signal in the desired signal's known signal section and the frequency of the interference signal in the interference signal's known signal section is equal to or less than a predetermined threshold, the combining unit 570-n may add a frequency shift to the desired signal or the interference signal so that the difference between the frequency of the desired signal and the frequency of the interference signal is greater than the predetermined threshold, and then combine the desired signal with the interference signal. The predetermined threshold is a value that is set in advance, for example, several kHz. FIG. 6 is a diagram showing an example of the desired signal and the interference signal input to the combining unit 570-n. The difference between the frequency of the desired signal 53-1 and the frequency of the interference signal 53-2 is 15 kHz in the example shown in FIG. 6.

When the difference between the frequency of the desired signal 53-1 and the frequency of the interference signal 53-2 is too small, the correlation between the known signals of the desired signal and the interference signal is high, and there is a possibility that the weight generation described later will not be performed appropriately. Therefore, by adding a frequency shift before combining, the weight generation can be performed appropriately.

The weight generation unit 580 generates weights based on the signals combined by the combining unit 570. The weights are used for control by the reception beam control unit 590.

The reception beam control unit 590 receives the reception frames for which the Doppler shift fluctuations have been compensated by the Doppler fluctuation compensation units 520-1 to 520-N and the weights generated by the weight generation unit 580. The reception beam control unit 590 performs adaptive array processing such as MMSE and CMA by multiplying the input reception frames by the weights and adding and combining them. As a result, the reception beam control unit 590 separates the interference signals in the spatial domain and extracts the desired signals. The reception beam control unit 590 outputs the extracted desired signals to the terminal signal decoding unit 443.

The operation of the wireless communication system 100 will be described. FIG. 7 is a flowchart showing the processing of the wireless communication system 100 when a terminal uplink signal is transmitted from the terminal station 200. The terminal station 200 acquires data detected by an external or internal sensor (not shown) at any time and writes the acquired data to the transmission data storage unit 210 (step S111). The transmitting unit 220 reads the sensor data from the transmission data storage unit 210 as terminal transmission data. The transmitting unit 220 wirelessly transmits a terminal uplink signal in which the terminal transmission data is set from the antenna 230 at a transmission start timing obtained in advance based on the orbit information of the LEO satellite carrying the mobile relay station 300 (step S112). The terminal station 200 repeats the processing from step S111.

The receiving units 321-1 to 321-N of the mobile relay station 300 receive the terminal uplink signal transmitted from the terminal station 200 (step S121). Note that uplink signals of the same frequency may be transmitted simultaneously from a plurality of terminal stations 200. In this case, desired signals transmitted at the same time and with the same frequency interfere with each other, but the signals are separated by reception beam control, and each signal can be received. The frequency conversion unit 322-n frequency-converts the terminal uplink signal received by the receiving unit 321-n from an RF signal to a baseband signal.

The reception waveform recording unit 323-n writes reception waveform information that associates waveform data representing the waveform of the terminal uplink signal of which the frequency has been converted by the frequency conversion unit 322-n with the reception time and antenna identification information of the antenna 310-n in the data storage unit 330 (step S122). The mobile relay station 300 repeats the processing from step S121.

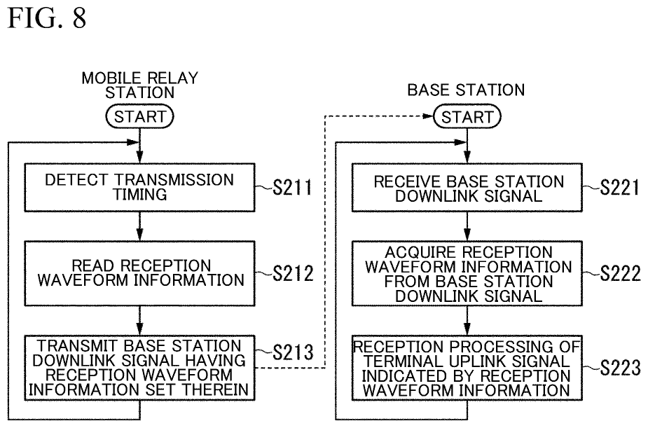

FIG. 8 is a flowchart showing the processing of the wireless communication system 100 when a base station downlink signal is transmitted from the mobile relay station 300. When the control unit 342 included in the base station communication unit 340 of the mobile relay station 300 detects arrival of a transmission start timing stored in the storage unit 341, the control unit 342 instructs the transmission data modulation unit 343 and the transmitting unit 344 to transmit the reception waveform information (step S211).

The transmission data modulation unit 343 reads the reception waveform information from the data storage unit 330 as transmission data (step S212). The reception waveform information read by the transmission data modulation unit 343 from the storage unit 341 is reception waveform information with a reception time set after the reception time set in the reception waveform information last read by the transmission data modulation unit 343. The transmission data modulation unit 343 converts the acquired transmission data into parallel signals and then modulates them.

The transmitting unit 344 weights the transmission data modulated by the transmission data modulation unit 343 with the weight instructed by the control unit 342, and generates a base station downlink signal, which is a transmission signal to be transmitted from each antenna 350. The transmitting unit 344 transmits the generated base station downlink signal from the antenna 350, for example, by MIMO (step S213). The mobile relay station 300 repeats the processing from step S211.

Each antenna station 410 of the base station 400 receives a base station downlink signal from the mobile relay station 300 (step S221). Each antenna station 410 converts the received base station downlink signal into an electrical signal and outputs the reception signal to the receiving unit 420. The receiving unit 420 synchronizes the timings of the reception signals received from each antenna station 410. The receiving unit 420 multiplies the reception signals received by each antenna station 410 by a weight and adds them. The base station signal reception processing unit 430 decodes the added reception signal. As a result, the base station signal reception processing unit 430 obtains reception waveform information (step S222). The base station signal reception processing unit 430 outputs the reception waveform information to the terminal signal reception processing unit 440.

The terminal signal reception processing unit 440 performs processing of receiving the terminal uplink signal indicated by the reception waveform information (step S223). Specifically, the distribution unit 441 reads waveform data having the same reception time from the reception waveform information. The distribution unit 441 outputs the read waveform data and the antenna identification information of the waveform data to the signal processing unit 442. The signal processing unit 442 performs frame detection (terminal signal detection), Doppler shift fluctuation compensation, filtering, and reception beam control on the reception signal indicated by the waveform data output from the distribution unit 441. The signal processing unit 442 outputs the reception signal subjected to reception beam control to the terminal signal decoding unit 443. The terminal signal decoding unit 443 performs reception processing performed by a general wireless communication device on the signal input from the signal processing unit 442 and decodes the signal to obtain the terminal transmission data transmitted from the terminal station 200. The base station 400 repeats the processing from step S221.

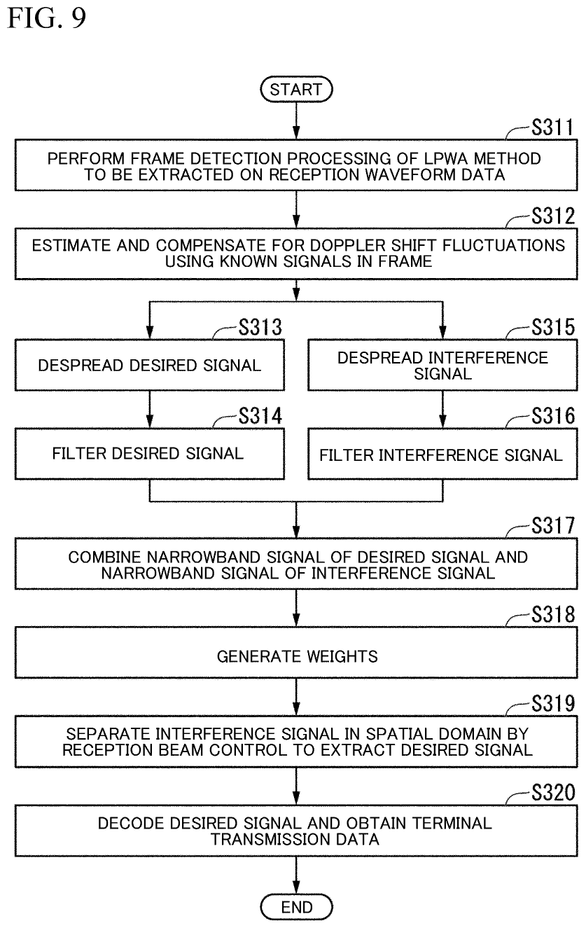

FIG. 9 is a flowchart showing the processing of the signal processing unit 442 and the terminal signal decoding unit 443 of the base station 400. The processing shown in FIG. 9 is performed in the processing of step S223 in FIG. 8. The signal processing unit 442 and the terminal signal decoding unit 443 perform the processing shown in FIG. 9 for each desired signal. The correspondence between the reception time and the desired signal may be calculated in advance based on the orbit information of the LEO satellite carrying the mobile relay station 300 and the position of each terminal station 200.

The frame detection units 510-1 to 510-N of the signal processing unit 442 respectively receive, as input, the waveform data of the receiving antennas #1 to #N read by the distribution unit 441. The frame detection unit 510-n performs frame detection processing for detecting frames of the LPWA method to be extracted on the input reception waveform data (step S311). The LPWA method to be extracted is the LPWA method used for the desired signal. In the frame detection processing, the frame detection unit 510-n reads a plurality of transmission known signals to which different types of frequency shifts are added, or a plurality of transmission known signals to which combinations of different types of frequency shifts and different types of frequency fluctuations are added, from a storage unit inside or outside the frame detection unit 510-n. These transmission known signals are known signals defined by the frame format of the LPWA method to be extracted. The frame detection unit 510-n calculates the cross-correlation between each of the plurality of transmission known signals that have been read and the reception signal waveform indicated by the waveform data of the receiving antenna #n. The frame detection unit 510-n detects the desired signal's known signal section and the interference signal's known signal section in the waveform data of the receiving antenna #n based on the position of the reception signal waveform where the maximum correlation value or a correlation value equal to or greater than a threshold is obtained. The frame detection unit 510-n extracts the desired signal's known signal section and the interference signal's known signal section detected from the waveform data of the receiving antenna #n, and outputs them to the Doppler fluctuation compensation unit 520-n.

The Doppler fluctuation compensation unit 520-n estimates the Doppler shift fluctuation of the frame section extracted by the frame detection unit 510-n by the above-mentioned method A or method B using a known signal. The Doppler fluctuation compensation unit 520-n performs compensation to cancel the estimated Doppler shift fluctuation on the desired signal in the desired signal's known signal section and the interference signal in the interference signal's known signal section (step S312). The Doppler fluctuation compensation unit 520-n outputs the desired signal and interference signal for which the Doppler shift fluctuations have been compensated to the first despreading unit 530-n, the second despreading unit 540-n, and the reception beam control unit 590-n.

The first despreading unit 530-nperforms despreading on the desired signal in the desired signal's known signal section that has been subjected to Doppler shift fluctuation compensation by the Doppler fluctuation compensation unit 520-n (step S313). The first filter 550-n performs filtering on the desired signal in the desired signal's known signal section that has been despread by the first despreading unit 530-n (step S314). The second despreading unit 540-n performs despreading on the interference signal in the known signal section of the interference signal that has been subjected to Doppler shift fluctuation compensation by the Doppler fluctuation compensation unit 520-n (step S315). The second filter 560-n performs filtering on the interference signal in the known signal section of the interference signal that has been despread by the second despreading unit 540-n (step S316).

Steps S313 and S314 and steps S315 and S316 are performed in parallel.

The combining unit 570-n combines the narrowband signal of the desired signal filtered by the first filter 550-n and the narrowband signal of the interference signal filtered by the second filter 560-n (step S317).

The weight generation unit 580 generates weights based on the signal combined by the combining unit 570 (step S318).

The reception beam control unit 590 performs reception beam control using an adaptive array based on the weights generated by the weight generation unit 580 for the reception frames for which the Doppler shift fluctuations have been compensated by the Doppler fluctuation compensating units 520-1 to 520-N, thereby separating the interference signals in the spatial domain and extracting the desired signals (step S319). The reception beam control unit 590 outputs the extracted desired signals to the terminal signal decoding unit 443. The terminal signal decoding unit 443 performs decoding processing on the desired signal input from the reception beam control unit 590 to obtain terminal transmission data (step S320).

As described above, the signal processing unit 442 of the base station 400 band-limits the desired signal's known signal section and the interference signal's known signal section using narrowband filters so that the signal sections overlap in time to generate weights for reception beam control. Therefore, the signal processing unit 442 can perform reception beam control, including interference signals, while suppressing the effects of thermal noise. Therefore, the signal processing unit 442 can realize appropriate reception beam control even when the reception level is very small.

### Second Embodiment

In the first embodiment, known signals are used to estimate and compensate for Doppler shift fluctuations. However, known signals such as preambles are signal sequences common to terminals of the same LPWA method. As the number of satellite IoT terminals and terrestrial IoT terminals increases year by year and the interference between the signals becomes more frequent, the estimation accuracy and compensation accuracy of the Doppler shift fluctuation will deteriorate due to the influence of the same known signal contained in the interference signal, and narrowbanding of the desired signal may become difficult. In order to suppress the deterioration of the characteristics of the narrowbanding of the desired signal by the Doppler shift fluctuation compensation even in a situation where interference occurs more frequently, in the second embodiment, the Doppler shift fluctuation is blindly compensated for without using a known signal, and the desired signal is narrowbanded before reception beam control is performed. The second embodiment will be described focusing on the differences from the first embodiment.

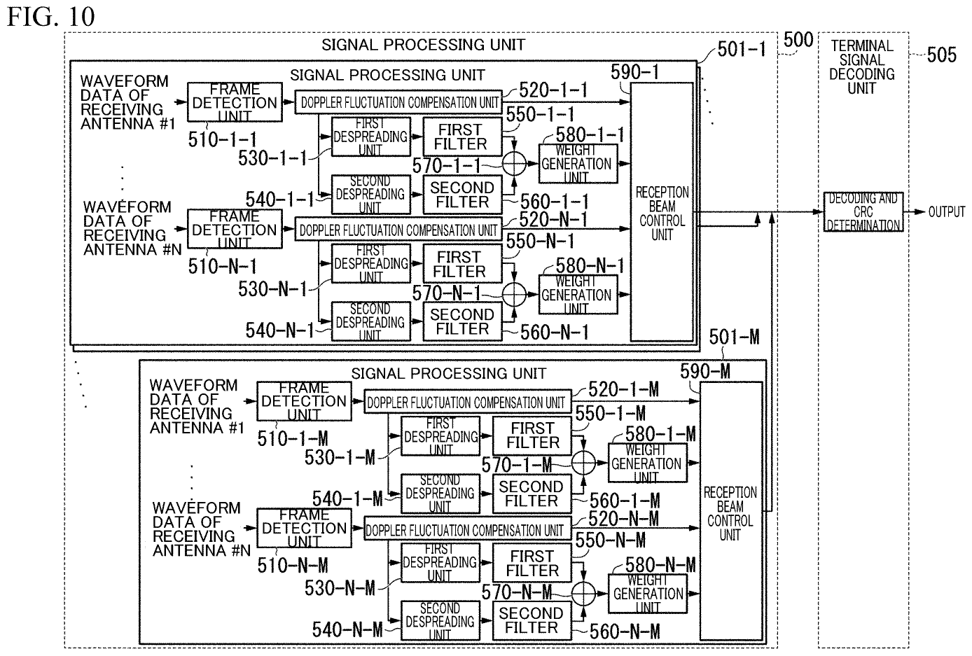

The configuration of the wireless communication system of the second embodiment is the same as that of the wireless communication system 100 of the first embodiment shown in FIG. 2. The configuration of the base station of the second embodiment is the same as that of the base station 400 of the first embodiment shown in FIG. 3, except for the following points. That is, the base station 400 of the second embodiment includes a signal processing unit 500 and a terminal signal decoding unit 505 shown in FIG. 10 instead of the signal processing unit 442 and the terminal signal decoding unit 443 of the first embodiment shown in FIG. 4.

FIG. 10 is a block diagram showing the configuration of the signal processing unit 500 of the second embodiment. The signal processing unit 500 has first to M-th processing units 501-1 to 501-M, which are processing planes for compensating for M types of Doppler shift fluctuations, Δf₁ (t), Δf₂ (t), Δf_{M} (t). For example, assume that the Doppler shift fluctuations assumed based on the terminal uplink signal frequency, which is the frequency of the terminal uplink signal transmitted by the terminal station 200, and the orbit altitude of the satellite carrying the mobile relay station 300 at each time are −300 Hz/s to −50 Hz/s. When dividing the range from 50 Hz/s to 300 Hz/s into M types at intervals of several Hz, the signal processing unit 500 has first to M-th processing units 501-1 to 501-M, which are processing planes corresponding to the M types of Doppler shift fluctuations. The required interval width differs depending on the characteristics of the LPWA method signal to be extracted, and is determined by a prior system design. The first to M-th processing units 501-1 to 501-M perform processing such as Doppler shift fluctuation compensation, frame detection, filtering, and reception beam control on the waveform data of the receiving antennas #1 to #N, respectively. Note that a description of the receiving processing performed by the signal processing unit 500 and other general wireless communication devices will be omitted.

The terminal signal decoding unit 505 performs decoding processing on the output of the reception beam control in each of the M processing planes of the first to M-th processing units 501-1 to 501-M. The terminal signal decoding unit 505 outputs the decoding result of the processing plane where decoding was successful as the processing result of the corresponding functional unit. The terminal signal decoding unit 505 determines that decoding is successful, for example, when the result of the CRC (Cyclic Redundancy Check) determination is OK.

The m-th processing unit 501-m (m is an integer of 1 or more and M or less) includes frame detection units 510-1-m to 510-N-m, Doppler fluctuation compensation units 520-1-m to 520-N-m, first despreading units 530-1-m to 530-N-m, second despreading units 540-1-m to 540-N-m, first filters 550-1-m to 550-N-m, second filters 560-1-m to 560-N-m, combining units 570-1-m to 570-N-m, weight generation units 580-1-m to 580-N-m, and a reception beam control unit 590-m.

The frame detection unit 510-n-m receives, as input, the waveform data of the receiving antenna #n. The frame detection unit 510-n-m performs frame detection on the waveform data of the receiving antenna #n by performing the same processing as the frame detection unit 510-n in the first embodiment. That is, the frame detection unit 510-n-m calculates the cross-correlation between the transmission known signal and the reception signal waveform indicated by the waveform data. The frame detection unit 510-n-m searches for the transmission known signal for which the correlation value of the cross-correlation reaches the maximum or is equal to or greater than a threshold, and detects, for example, the beginning position of the reception frame based on the position of the reception waveform where the correlation value was obtained. When the frame detection unit 510-n-m detects the beginning position of the reception frame, the frame detection unit 510-n-m extracts a section of the frame length defined by the frame format from the waveform data, or identifies the frame end position based on the frame length information written in the header of the reception frame and extracts the frame section. As in the first embodiment, the frequency shift added to the searched transmission known signal is approximately the same as the Doppler shift received by the terminal uplink signal of the desired signal. Therefore, the frequency shift added to the searched transmission known signal may be used as an estimated value of the Doppler shift, and Doppler shift compensation may be performed on the waveform data. Alternatively, the frame detection unit 510-n-m may use a commonly used method, such as detecting a section where the time domain waveform has a certain amplitude or more as a section that includes a frame transmitted by the terminal station 200.

The Doppler fluctuation compensation unit 520-n-m, the first despreading unit 530-n-m, the second despreading unit 540-n-m, the first filter 550-n-m, the second filter 560-n-m, the combining unit 570-n-m, the weight generation unit 580-n-m, and the reception beam control unit 590-m perform the same processing as the Doppler fluctuation compensation unit 520-n, the first despreading unit 530-n, the second despreading unit 540-n, the first filter 550-n, the second filter 560-n, the combining unit 570-n, the weight generation unit 580-n, and the reception beam control unit 590, respectively, in the first embodiment.

The terminal signal decoding unit 505 decodes the reception signals input from each of the first to M-th processing units 501-1 to 501-M, and performs CRC determination on the decoding results. The terminal signal decoding unit 505 outputs the decoding results that are determined to be successful by the CRC determination.

The operation of the wireless communication system 100 of the second embodiment will be described. The wireless communication system 100 of the second embodiment performs the same processing as the wireless communication system 100 of the first embodiment shown in FIGS. 7 and 8.

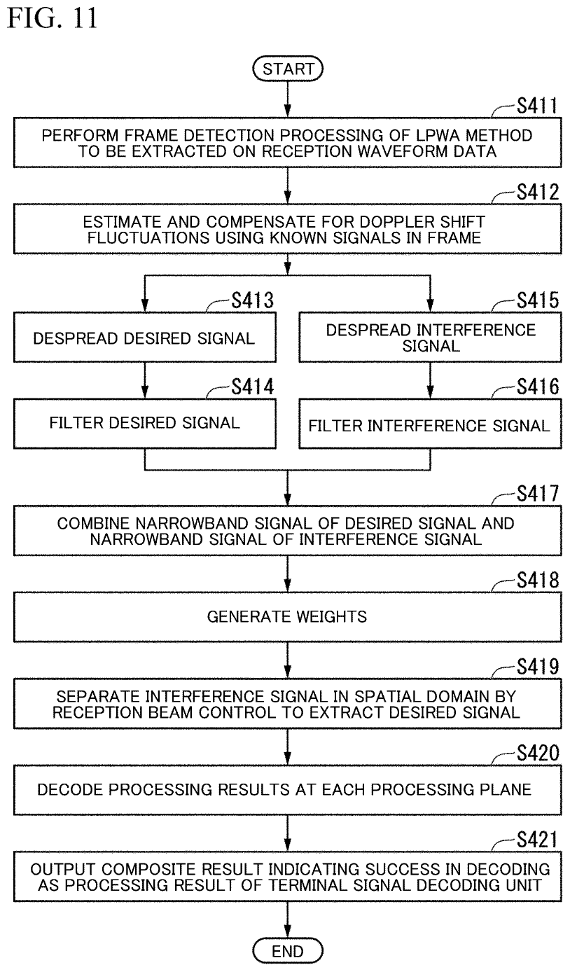

FIG. 11 is a flowchart showing the processing of the signal processing unit 500 and the terminal signal decoding unit 505 according to the second embodiment. The processing shown in FIG. 11 is performed in the processing of step S223 in FIG. 8. The signal processing unit 500 and the terminal signal decoding unit 505 perform the processing shown in FIG. 11 for each desired signal.

The signal processing unit 500 inputs waveform data of the receiving antennas #1 to #N to the first to M-th processing units 501-1 to 501-M. The first to M-th processing units 501-1 to 501-M each perform frame detection on the input waveform data (step S411).

The first to M-th processing units 501-1 to 501-M compensate for the Doppler shift fluctuation of the waveform data for which frame detection has been performed (step S412).

The first to M-th processing units 501-1 to 501-M each perform despreading (step S413) and filtering (step S414) on the desired signal for which the Doppler shift fluctuations have been compensated. The first to M-th processing units 501-1 to 501-M each perform despreading (step S415) and filtering (step S416) on the interference signal for which the Doppler shift fluctuations have been compensated.

The first to M-th processing units 501-1 to 501-M each combine the narrowband signal of the desired signal to be filtered and the narrowband signal of the interference signal to be filtered (step S417). The first to M-th processing units 501-1 to 501-M each generate a weight based on the signal combined by the combining unit 570 (step S418). The first to M-th processing units 501-1 to 501-M each perform reception beam control using an adaptive array based on the generated weight for the reception frame for which the Doppler shift fluctuations have been compensated, thereby separating the interference signal in the spatial domain and extracting the desired signal (step S419).

The terminal signal decoding unit 505 performs decoding processing on the desired signal input from each of the reception beam control units 590-1 to 590-M of the first to M-th processing units 501-1 to 501-M (step S420). The terminal signal decoding unit 505 performs CRC determination on the decoding results of the desired signals input from the M processing planes of the first to M-th processing units 501-1 to 501-M. The terminal signal decoding unit 505 determines that the decoding is successful if the CRC determination result is OK. The terminal signal decoding unit 505 outputs the decoding result of the processing plane where the decoding was successful as the processing result (step S421).

Note that the signal processing unit 500 may perform subsequent processing only on the processing plane where the cross-correlation value of the frame detection is equal to or greater than the threshold. That is, the frame detection unit 510-n-m determines whether one or more of the cross-correlation values calculated when each of the frame detection units 510-1-m to 510-N-m performs the frame detection processing on the waveform data of the receiving antennas #1 to #M are equal to or greater than a preset threshold. If there is a cross-correlation value equal to or greater than the threshold, the frame detection unit 510-n-m outputs the frame detection result to the downstream Doppler fluctuation compensation unit 520-n-m. On the other hand, if there is no cross-correlation value equal to or greater than the threshold, the frame detection unit 510-n-m discards the waveform data without inputting it to the Doppler fluctuation compensation unit 520-n-m. The other processing is the same as that of the signal processing unit 500 described above. This allows the amount of calculation to be reduced compared to the signal processing unit 500 of the basic form.

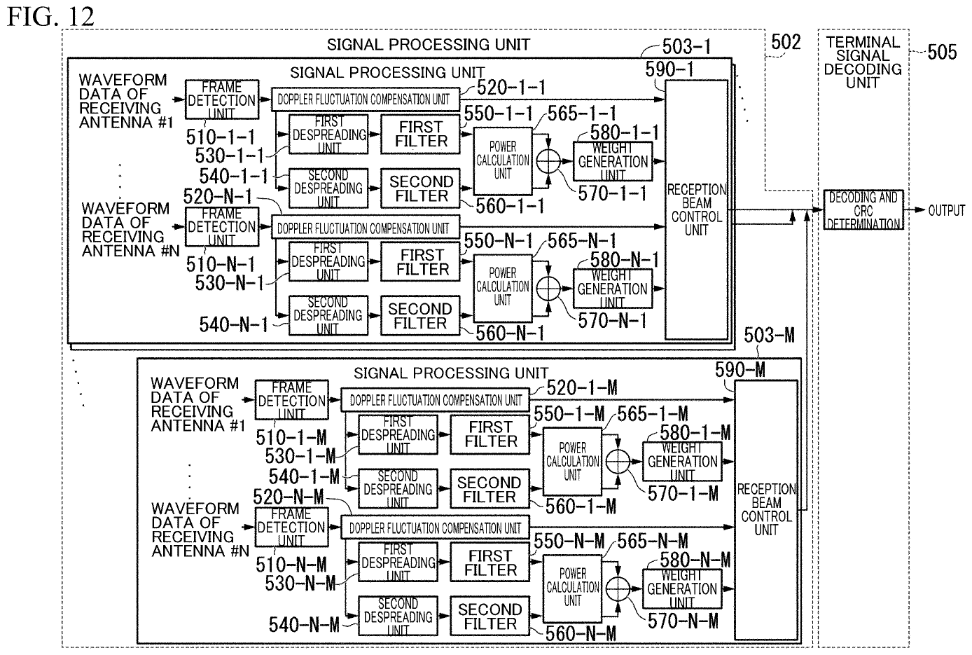

Also, as shown in FIG. 12, the configuration may be such that subsequent processing is performed only on a processing plane where the power in the filter band after filtering is equal to or greater than a threshold.

FIG. 12 is a diagram showing the configuration of a signal processing unit 502 according to a modified example of the second embodiment. In FIG. 12, the same parts as those in the signal processing unit 501 shown in FIG. 10 are denoted by the same reference numerals and the description thereof will be omitted. The signal processing unit 502 has first to M-th processing units 503-1 to 503-M, which are processing planes for compensating for M types of Doppler shift fluctuations, Δf₁ (t), Δf₂ (t), . . . Δf_{M} (t) .

The m-th processing unit 503-m differs from the m-th processing unit 501-m shown in FIG. 10 in that it further includes power calculation units 565-1-m to 565-N-m.

The power calculation unit 565-n-m receives, as inputs, the narrowband signal of the antenna #n that has been narrowband filtered from the first filter 550-n-m and the second filter 560-n-m. The power calculation unit 565-n-m calculates the power of the input waveform data. The power calculation unit 565-n-m determines whether one or more of the powers of the narrowband signals of receiving antennas #1 to #N calculated by each of the power calculation units 565-1-m to 565-N-m is equal to or greater than a preset threshold. If there is power equal to or greater than the threshold, the power calculation unit 565-n-m outputs the narrowband signals input from the first filter 550-n-m and the second filter 560-n-m to the combining unit 570-n-m. On the other hand, if there is no power equal to or greater than the threshold, the power calculation unit 565-n-m discards the narrowband signal without inputting it to the combining unit 570-n-m.

Alternatively, the power calculation units 565-1-m to 565-N-m may output information about the calculated power to the reception beam control unit 590-m. The reception beam control unit 590-m performs reception beam control when one or more of the pieces of input power information is equal to or greater than a preset threshold. The reception beam control unit 590-m may discard the narrowband signal without performing reception beam control if none of the input power information meets the threshold. Other processing is the same as that of the signal processing unit 500 described above. This allows the amount of calculation to be reduced compared to the signal processing unit 500 of the basic form.

According to the present embodiment, since Doppler shift fluctuations are estimated and compensated for blindly without using a known signal, even in a situation where interference occurs frequently, it is possible to realize reception beam control with good signal separation performance.

### Third Embodiment

In the first and second embodiments, the frequency conversion of the terminal uplink signal is performed in the mobile relay station, but the frequency conversion may be performed in the base station. In the third embodiment, a wireless communication system in which frequency conversion is performed in the base station will be described, focusing on the differences from the first and second embodiments described above.

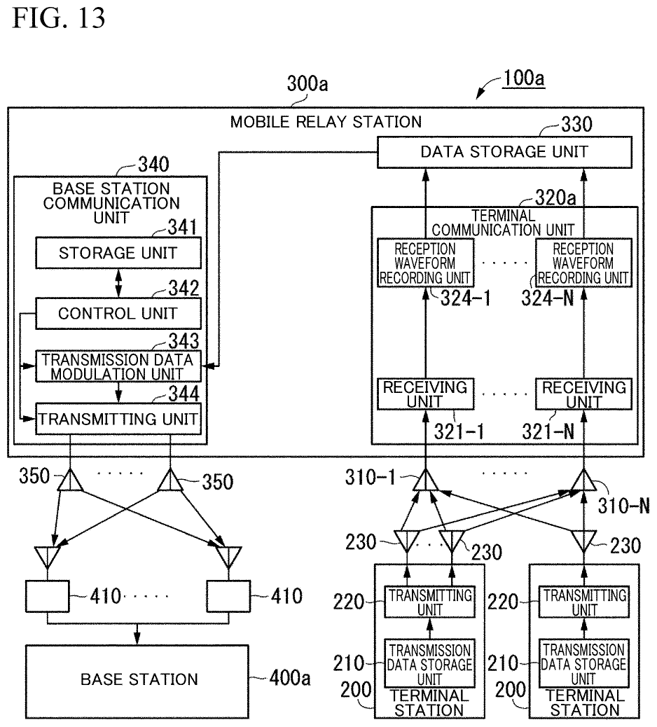

FIG. 13 is a diagram showing the configuration of a wireless communication system 100a according to the third embodiment. In FIG. 13, the same parts as those in the wireless communication system 100 according to the first embodiment shown in FIG. 2 are denoted by the same reference numerals and the description thereof will be omitted. The wireless communication system 100a has a terminal station 200, a mobile relay station 300a, and a base station 400a.

The mobile relay station 300a shown in FIG. 13 differs from the mobile relay station 300 shown in FIG. 2 in that it includes a terminal communication unit 320a instead of the terminal communication unit 320. The terminal communication unit 320a includes N receiving units 321 and N reception waveform recording units 324. The reception waveform recording unit 324 connected to the receiving unit 321-n is referred to as a reception waveform recording unit 324-n. The reception waveform recording unit 324-n samples the reception waveform of the terminal uplink signal received by the receiving unit 321-n as an RF signal, and generates waveform data indicating the value obtained by the sampling. The reception waveform recording unit 324-n writes the reception waveform information, in which the antenna identification information of the antenna 310-n, the reception time of the terminal uplink signal at the antenna 310-n, and the generated waveform data are set, into the data storage unit 330.

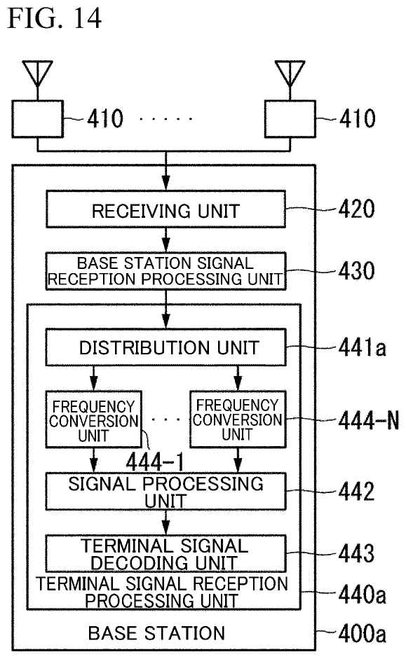

FIG. 14 is a diagram showing the configuration of the base station 400a. In FIG. 14, the same parts as those of the base station 400 shown in FIG. 3 are denoted by the same reference numerals and the description thereof will be omitted. The base station 400a shown in FIG. 14 differs from the base station 400 shown in FIG. 3 in that it includes a terminal signal reception processing unit 440a instead of the terminal signal reception processing unit 440. The terminal signal reception processing unit 440a includes a distribution unit 441a, N frequency conversion units 444, a signal processing unit 442, and a terminal signal decoding unit 443. The N frequency conversion units 444 are referred to as frequency conversion units 444-1 to 444-N, respectively.

The distribution unit 441a reads waveform data of the same reception time from the reception waveform information and outputs the read waveform data to the frequency conversion units 444-1 to 444-N according to the antenna identification information associated with the waveform data. In other words, the distribution unit 441a outputs the waveform data of the receiving antenna #n to the frequency conversion unit 444-n. The waveform data of the receiving antenna #n is associated with the antenna identification information of the antenna 310-n. The frequency conversion unit 444-n frequency-converts the signal represented by the input waveform data of the receiving antenna #n from an RF signal to a baseband signal. A quadrature demodulator or the like is used for the frequency conversion. The frequency conversion units 444-1 to 444-N each output the frequency-converted signal to the signal processing unit 442.

The wireless communication system 100a of the third embodiment performs the same processing as the wireless communication system 100 of the first embodiment shown in FIGS. 7 and 8, except for the following points. That is, in step S122 of FIG. 7, the reception waveform recording unit 324-n of the mobile relay station 300a writes reception waveform information in which the waveform data representing the waveform of the terminal uplink signal received by the receiving unit 321-n is associated with the reception time and the antenna identification information of the antenna 310-n, into the data storage unit 330. Also, in step S223 of FIG. 8, the distribution unit 441a reads waveform data having the same reception time from the reception waveform information. The distribution unit 441a outputs the read waveform data to the frequency conversion units 444-1 to 444-N according to the antenna identification information associated with the waveform data. The frequency conversion unit 444-n frequency-converts the reception signal represented by the waveform data of the antenna #n from an RF signal to a baseband signal. The frequency conversion unit 444-n outputs the frequency-converted reception signal to the signal processing unit 442. The processing after the reception signals of the antennas #1 to #N are input from each of the frequency conversion units 444-1 to 444-N to the signal processing unit 442 is the same as that of the first embodiment described above.

The signal processing unit 442 performs the processing of the first embodiment shown in FIG. 9 using the reception signals of the antennas #1 to #N input from each of the frequency conversion units 444-1 to 444-N. Alternatively, when the mobile relay station 300a includes the signal processing unit 500 and the terminal signal decoding unit 505 of the second embodiment shown in FIG. 10 instead of the signal processing unit 442 and the terminal signal decoding unit 443, the signal processing unit 500 performs the processing of the second embodiment using the reception signals of the antennas #1 to #N input from the frequency conversion units 444-1 to 444-N, respectively.

### Fourth Embodiment

In the above-mentioned first to third embodiments, the base station decodes the terminal uplink signal. In the present embodiment, the mobile relay station decodes the terminal uplink signal. The present embodiment will be described focusing on the differences from the first to third embodiments.

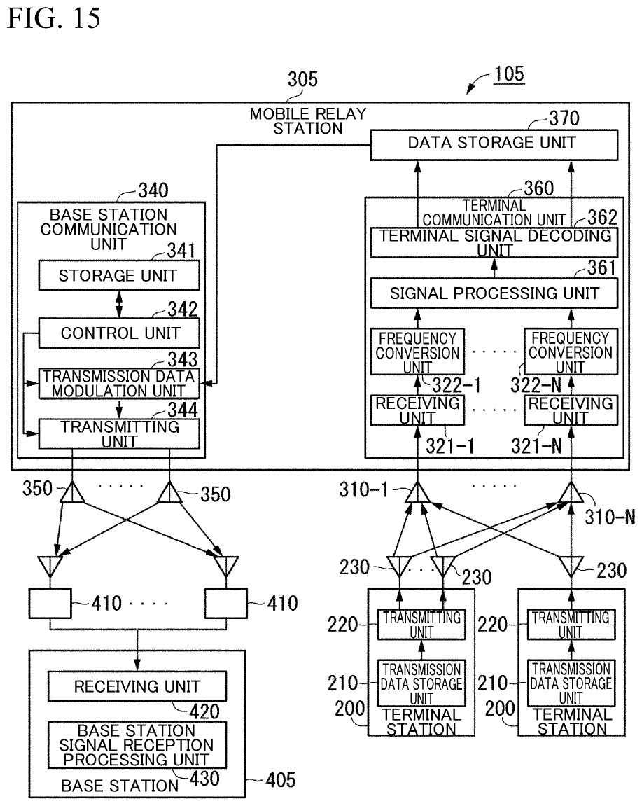

FIG. 15 is a configuration diagram of a wireless communication system 105 according to the fourth embodiment. In this figure, the same components as those of the wireless communication system 100 of the first embodiment shown in FIG. 2 are denoted by the Same reference numerals and the description thereof will be omitted. The wireless communication system 105 includes a terminal station 200, a mobile relay station 305, and a base station 405. The mobile relay station 305 is an example of a signal processing device.

The mobile relay station 305 includes antennas 310-1 to 310-N (N is an integer of 2 or more), a terminal communication unit 360, a data storage unit 370, a base station communication unit 340, and M antennas 350 (M is an integer of 1 or more).

The terminal communication unit 360 includes receiving units 321-1 to 321-N, frequency conversion units 322-1 to 322-N, a signal processing unit 361, and a terminal signal decoding unit 362. The signal processing unit 361 and the terminal signal decoding unit 362 have the same functions as the signal processing unit 442 and the terminal signal decoding unit 443 of the first embodiment shown in FIG. 4, or the signal processing unit 500 and the terminal signal decoding unit 505 of the second embodiment shown in FIG. 10, respectively. The terminal signal decoding unit 362 writes the terminal transmission data obtained as a result of decoding to the data storage unit 370. The data storage unit 370 stores terminal transmission data transmitted by each terminal station 200. The transmission data modulation unit 343 of the base station communication unit 340 reads the terminal transmission data from the data storage unit 370 as transmission data.

The base station 405 includes one or more antenna stations 410, a receiving unit 420, and a base station signal reception processing unit 430. The base station signal reception processing unit 430 decodes the reception signal combined in the receiving unit 420 to obtain terminal transmission data.

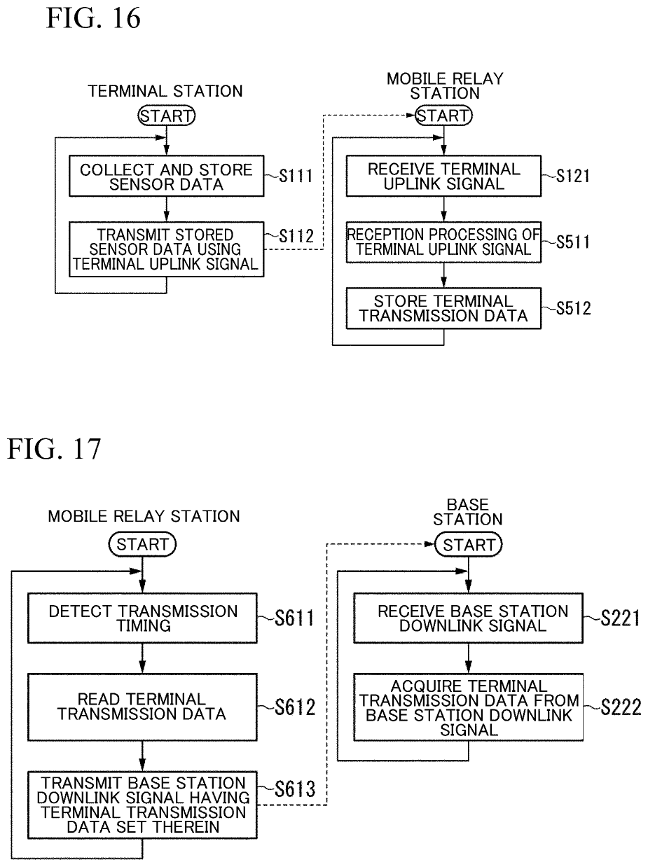

The operation of the wireless communication system 105 will be described. FIG. 16 is a flowchart showing the processing of the wireless communication system 105 when an uplink signal is transmitted from the terminal station 200. In FIG. 16, the same processing as the processing shown in the flowchart of the first embodiment shown in FIG. 7 is designated by the same reference numeral.

Processing of the terminal station 200 in steps S111 to S112 is the same as that of the first embodiment shown in FIG. 7. The processing of the mobile relay station 305 in step S121 is the same as that of the first embodiment shown in FIG. 7. That is, the receiving units 321-1 to 321-N of the mobile relay station 305 receive the terminal uplink signal transmitted from the terminal station 200 (step S121). The frequency conversion unit 322-n frequency-converts the terminal uplink signal of the receiving antenna #n received by the receiving unit 321-n from an RF signal to a baseband signal. The signal processing unit 361 receives, as input, the terminal uplink signals of the receiving antennas #1 to #N that have been frequency converted to baseband signals from each of the frequency conversion units 322-1 to 322-N.

The signal processing unit 361 performs reception processing on the terminal uplink signals of the receiving antennas #1 to #N input from each of the frequency conversion units 322-1 to 322-N. The terminal signal decoding unit 362 decodes the signal that has been received and processed by the signal processing unit 361 by performing reception processing that is performed by a general wireless communication device and obtains the terminal transmission data transmitted from the terminal station 200 (step S511). The terminal signal decoding unit 362 writes the terminal transmission data obtained by decoding to the data storage unit 370 (step S 512).

In step S511, the signal processing unit 361 and the terminal signal decoding unit 362 use the terminal uplink signals of the receiving antennas #1 to #N to perform the same processing as the signal processing unit 442 and the terminal signal decoding unit 443 of the first embodiment shown in FIG. 9 for each desired signal. Alternatively, in step S511, the signal processing unit 361 and the terminal signal decoding unit 362 use the terminal uplink signals of the receiving antennas #1 to #N to perform the same processing as the signal processing unit 500 and the terminal signal decoding unit 505 of the second embodiment shown in FIG. 11 for each desired signal.

FIG. 17 is a flowchart showing the processing of the wireless communication system 105 when a base station downlink signal is transmitted from the mobile relay station 305. In FIG. 17, the same processing as the processing shown in the flowchart of the first embodiment shown in FIG. 8 is designated by the same reference numeral.

The mobile relay station 305 performs the same processing as steps S211 to S213 in FIG. 7 (steps S611 to S613). However, in step S611, the control unit 342 instructs the transmission data modulation unit 343 and the transmitting unit 344 to transmit the terminal transmission data. In addition, in step S612, the transmission data modulation unit 343 reads the terminal transmission data stored in the data storage unit 370 as the transmission data. In step S613, the transmitting unit 344 transmits the base station downlink signal in which the terminal transmission data is set from the antenna 350. The mobile relay station 305 repeats the processing from step S611.

The base station 405 receives the base station downlink signal from the mobile relay station 305 in the same manner as in the first embodiment (step S221). The receiving unit 420 synchronizes the timing of the reception signals received from each antenna station 410. The receiving unit 420 multiplies the reception signals received by each antenna station 410 by the weights and adds them. The base station signal reception processing unit 430 decodes the added reception signals to obtain terminal transmission data (step S621). The base station 405 repeats the processing from step S221.

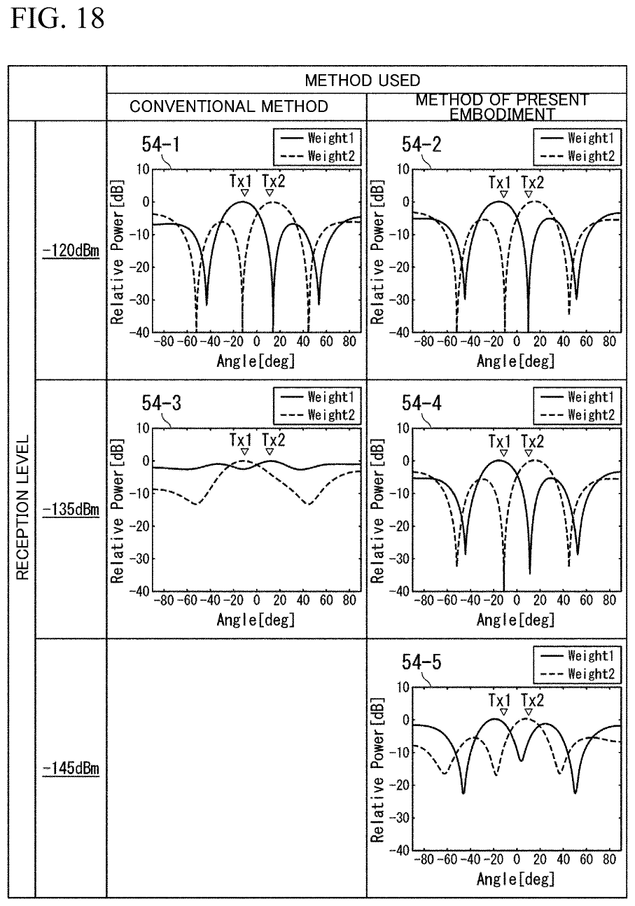

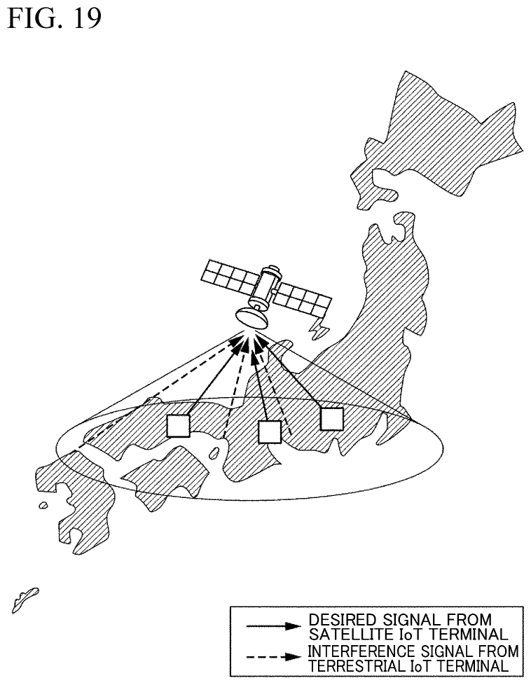

Below, the results of comparing the conventional method with the method of the present embodiment are shown. In the conventional method, the reception waveform data is input directly to the weight generation unit to generate a weight, whereas in the method of the present embodiment, as explained above, known signal sections of the desired signal and the interference signal are extracted, despread, filtered, and combined and the resulting waveform data is input to the weight generation unit to generate a weight. FIG. 18 is a diagram showing signals processed by the terminal signal reception processing unit 440 when the conventional method and the method of the present embodiment are applied. The signal separation performance of the conventional method and the method of the present embodiment was evaluated by changing the reception level of the signal received by the receiving unit 420.

Graph 54-1 shows when the conventional method is applied and the reception level of −120 dBm. Graph 54-2 shows when the method of the present embodiment is applied and the reception level is −120 dBm. Graph 54-3 shows when the conventional method is applied, and the reception level is −135 dBm. Graph 54-4 shows when the method of the present embodiment is applied and the reception level is −135 dBm. Graph 54-5 shows when the method of the present embodiment is applied and the reception level is −145 dBm. This is an evaluation when the signal T×1 arrives from a direction of −10 deg from the front of the mobile relay station, and the signal T×2 arrives from a direction of 10 deg from the front of the mobile relay station, causing interference. In graphs 54-1 to 54-5, the solid lines show the reception beam patterns when a reception beam is formed with T×1 as the desired signal and T×2 as the interference signal, and the dashed lines show the reception beam patterns when a reception beam is formed with T×2 as the desired signal and T×1 as the interference signal.

In the conventional method, when the reception level is −120 dBm, a strong reception beam is formed for the desired signal, and a null beam is formed for the interference signal, and the desired signal and the interference signal can be separated. However, when the reception level is −135 dBm, the beam is not properly formed and the desired signal and the interference signal cannot be separated. However, in the method of the present embodiment, even when the reception level is −135 dBm or −145 dBm, the beam is properly formed and the desired signal and the interference signal can be separated.

In the above-mentioned present embodiment, the mobile relay station 300 and the base station 400, the mobile relay station 300a and the base station 400a, and the mobile relay station 305 and the base station 405 communicate by MIMO, but the present invention is not limited to this. For example, the mobile relay stations 300, 300a, and 305 may transmit base station downlink signals to the base stations 400, 400a, and 405 by one antenna 350. Similarly, the base stations 400, 400a, and 405 may receive base station downlink signals from the mobile relay stations 300, 300a, and 305 using one antenna station or one antenna instead of a plurality of antenna stations 410.

In the above-mentioned present embodiment, the moving body on which the mobile relay station is mounted is described as an LEO satellite, but it may be a geostationary satellite or another flying object flying in the sky, such as a drone or HAPS. The above embodiment is also applicable to a case where a stationary relay station receives a wireless signal from, for example, a terminal station moving in a fixed orbit.

In the above-described embodiment, the first despreading units 530-1 to 530-N, 530-1-1 to 530-N-M, the second despreading units 540-1 to 540-N, 540-1-1 to 540-N-M, the first filters 550-1 to 550-N, 550-1-1 to 550-N-M, the second filters 560-1 to 560-N, 560-1-1 to 560-N-M, the combining units 570-1 to 570-N, 570-1-1 to 570-N-M, and the weight generation units 580-1 to 580-N, 580-1-1 to 580-N-M each are provided in the same numbers as the frame detection units 510-1 to 510-N, 510-1-1 to 510-N-M and the Doppler fluctuation compensation units 520-1 to 520-N, 520-1-1 to 520-N-M in the signal processing units 442 and the first to M-th processing units 501-1 to 501-M, respectively, but the present invention is not limited to this. For example, each of the signal processing units 442 may include one first despreading unit 530, one second despreading unit 540, one first filter 550, one second filter 560, one combining unit 570, and one weight generation unit 580, and each of the n-th processing units 501-n may include one first despreading unit 530-n, one second despreading unit 540-n, one first filter 550-n, one second filter 560-n, one combining unit 570-n, and one weight generation unit 580-n. In this case, the first despreading unit 530, the second despreading unit 540, the first filter 550, the second filter 560, the combining unit 570, and the weight generation unit 580 process the signals output from each of the Doppler fluctuation compensation units 520-1 to 520-N independently.

According to the above-mentioned embodiment, it is possible to realize reception beam control capable of achieving sufficient signal separation performance even in a satellite IoT-PF with large Doppler shift fluctuation.

The above-described embodiment is more effective when the desired signal and the interference signal are modulated by LoRa, which is one of the LPWA methods. For example, when receiving an interference signal of another LPWA method such as Sigfox or ELTRES, since the interference signal is spectrum-spread by the LoRa despreading processing, and the interference effect on the desired signal is reduced by about 20 dB, there is a high possibility that separation is not necessary in the reception beam control.

All or part of the functions of the signal processing unit 442 and the terminal signal decoding unit 443 of the base station 400 or 400a, and the signal processing unit 361 and the terminal signal decoding unit 362 of the mobile relay station 305 may be realized by a processor such as a CPU (central processing unit) or a GPU (Graphics Processing Unit) reading and executing a program from a storage unit. In addition, all or part of the functions of the signal processing unit 442 and the terminal signal decoding unit 443 of the base station 400 or 400a, and the signal processing unit 361 and the terminal signal decoding unit 362 of the mobile relay station 305 may be realized using hardware such as an ASIC (Application Specific Integrated Circuit), a PLD (Programmable Logic Device), or an FPGA (Field Programmable Gate Array).

According to the above-mentioned embodiment, the signal processing device includes a frame detection unit, a combining unit, and a weight generation unit. For example, the signal processing device is the base station 400 or 400a, and the mobile relay station 305 of the embodiment. The frame detection unit extracts a desired signal's known signal section, which is a known signal section of the desired signal, and an interference signal's known signal section, which is a known signal section of the interference signal, from waveform data indicating the waveform of the wireless signal. The combining unit combines the desired signal and the interference signal so that the desired signal's known signal section and the interference signal's known signal section overlap in time. The weight generation unit generates weights for reception beam control based on the combined signal.

The combining unit may combine a signal generated by despreading and band-limiting the desired signal with a signal generated by despreading and band-limiting the interference signal.

The band in the band-limiting may be set according to the reception levels of the desired signal and the interference signal.

The combining unit may combine a narrowband signal extracted from the desired signal with a narrowband signal extracted from the interference signal after adding a frequency shift to a frequency of the desired signal or the interference signal so that a difference between the frequency of the desired signal in the desired signal's known signal section and the frequency of the interference signal in the interference signal's known signal section is equal to or greater than a predetermined threshold.

At least some of the functions of the signal processing device may be realized by a computer. In that case, a program for realizing the functions of the signal processing device may be recorded on a computer-readable recording medium, and the program recorded on the recording medium may be read into a computer system and executed to realize the functions. The computer system includes hardware such as a processor, an OS, and peripheral devices. The program of the signal processing device may be recorded on a computer-readable recording medium. The computer-readable recording medium is, for example, a portable medium such as a flexible disk, a magneto optical disk, a ROM, or a CD-ROM, or a storage device such as a hard disk built in a computer system. The program of the signal processing device may be transmitted via a telecommunications line.

Although the embodiment of the present invention has been described in detail with reference to the drawings, a specific configuration is not limited to the present embodiment and design within the scope of the gist of the present invention, and the like are included.

### REFERENCE SIGNS LIST

1, 100, 100a, 105 Wireless communication system
2, 200 Terminal station
3, 300, 300a, 305 Mobile relay station
4, 400, 400a, 405 Base station
21 Transmission data storage unit
22 Transmitting unit
31-1 to 31-N Receiving unit
32-1 to 32-N Waveform sampling unit
34 Base station communication unit
41 Base station receiving unit
42 Signal processing unit
210 Transmission data storage unit
220 Transmitting unit
230 Antenna
310-1 to 310-N, 350 Antenna
320, 320a Terminal communication unit
321-1 to 321-N Receiving unit
322-1 to 322-N Frequency conversion unit
323-1 to 323-N, 324-1 to 324-N Reception waveform recording unit
330 Data storage unit
340 Base station communication unit
341 Storage unit
342 Control unit
343 Transmission data modulation unit
344 Transmitting unit
360 Terminal communication unit
361 Signal processing unit
362 Terminal signal decoding unit
370 Data storage unit
400 Base station
410 Antenna station
420 Receiving unit
430 Base station signal reception processing unit
440, 440a Terminal signal reception processing unit
441, 441a Distribution unit
442 Signal processing unit
443 Terminal signal decoding unit
444-1 to 444-N Frequency conversion unit
500, 502 Signal processing unit
501-1, 503-1 First processing unit
501-2, 503-2 Second processing unit
501-M, 503-M M-th processing unit
505 Terminal signal decoding unit
510-1 to 510-N, 510-1-1 to 510-N-M Frame detection unit
520-1 to 520-N, 520-1-1 to 520-N-M Doppler fluctuation compensation unit
530-1 to 530-N, 530-1-1 to 530-N-M First despreading unit
540-1 to 540-N, 540-1-1 to 540-N-M Second despreading unit
550-1 to 550-N, 550-1-1 to 550-N-M First filter
560-1 to 560-N, 560-1-1 to 560-N-M Second filter
565-1 to 565-N, 565-1-1 to 565-N-M Power calculation unit
570-1 to 570-N, 570-1-1 to 570-N-M Combining unit
580-1 to 580-N, 580-1-1 to 580-N-M Weight generation unit
590, 590-1 to 590-M Reception beam control unit

1. A signal processing device comprising:
a frame detector configured to extract a desired signal's known signal section, which is a known signal section of a desired signal, and an interference signal's known signal section, which is a known signal section of an interference signal, from waveform data indicating a waveform of a wireless signal;
a combiner configured to combine the desired signal with the interference signal to obtain a combined signal so that the desired signal's known signal section and the interference signal's known signal section overlap in time; and
a weight generator configured to generate weights for reception beam control based on the combined signal.

2. The signal processing device according to claim 1, wherein
the combiner a signal generated by despreading and band-limiting the desired signal with a signal generated by despreading and band-limiting the interference signal.

3. The signal processing device according to claim 2, wherein a band in the band-limiting is set according to reception levels of the desired signal and the interference signal.

4. The signal processing device according to claim 2, wherein
the combiner combines a narrowband signal extracted from the desired signal with a narrowband signal extracted from the interference signal after adding a frequency shift to a frequency of the desired signal or the interference signal so that a difference between the frequency of the desired signal in the desired signal's known signal section and the frequency of the interference signal in the interference signal's known signal section is equal to or greater than a predetermined threshold.

5. A signal processing method comprising:
extracting a desired signal's known signal section, which is a known signal section of a desired signal, and an interference signal's known signal section, which is a known signal section of an interference signal, from waveform data indicating a waveform of a wireless signal;
combining the desired signal with the interference signal to obtain a combined signal so that the desired signal's known signal section and the interference signal's known signal section overlap in time; and
generation step of generating weights for reception beam control based on the combined signal.

6. The signal processing method according to claim 5, wherein
a signal generated by despreading and band-limiting the desired signal is combined with a signal generated by despreading and band-limiting the interference signal.

7. The signal processing method according to claim 6, wherein a band in the band-limiting is set according to reception levels of the desired signal and the interference signal.

8. The signal processing method according to claim 6, wherein
a narrowband signal extracted from the desired signal is combined with a narrowband signal extracted from the interference signal after adding a frequency shift to a frequency of the desired signal or the interference signal so that a difference between the frequency of the desired signal in the desired signal's known signal section and the frequency of the interference signal in the interference signal's known signal section is equal to or greater than a predetermined threshold.
